(19) United States
(12) Patent Application Publication
(10) Pub. No.: US 2012/0311556 A1
(43) Pub. Date: Dec. 6, 2012

(54) SERVER APPARATUS AND TELEPHONE SYSTEM AND FIRMWARE UPDATE CONTROL METHOD USED IN SERVER APPARATUS

(76) Inventor: Fumikazu Matsukawa, Koganei-shi (JP)

(21) Appl. No.: 13/371,212

(22) Filed: Feb. 10, 2012

(30) Foreign Application Priority Data
May 31, 2011 (JP) 2011-122414

(51) Int. Cl. G06F 9/44

(52) U.S. Cl. 717/171

(57) ABSTRACT

According to one embodiment, a server apparatus includes a timer, an acquisition module, a memory, and a controller. The timer measures a current time. The acquisition module acquires pieces of local time information from the terminals. The memory stores in a management table terminal IDs in association with pieces of local time information, and time differences between the pieces of local time information and the current time. The controller updates the firmware of each of the terminals sequentially, starting with a terminal with the sum of the time on the timer and the time difference is reached the update start time, based on the management table.

### CROSS-REFERENCE TO RELATED APPLICATIONS

This application is based upon and claims the benefit of priority from prior Japanese Patent Application No. 2011-122414, filed May 31, 2011, the entire contents of which are incorporated herein by reference.

### FIELD

Embodiments described herein relate generally to a server apparatus used in, for example, a VOIP (Voice Over Internet Protocol) system and a firmware update control method used in a server apparatus.

### BACKGROUND

In recent years, an IP telephone system has been popularized which transmits and receives images and audio in the form of packet data bidirectionally in real time via a packet communication network, such as a LAN (Local Area Network) or the Internet. In the IP telephone system, not only can audio communication be performed between IP terminals connected to the packet communication network, but also audio communication can be performed between an IP terminal and a telephone terminal connected to a public network and further can be performed between countries or between regions via a packet communication network.

In the IP telephone system, when a maintenance person specifies an IP terminal registered in a server via a maintenance screen and instructs the server to update its firmware, the update of the firmware in the specified IP terminal is started immediately.

When the update of the firmware is started, the user cannot use the terminal at all until the update has been completed. Therefore, actually, the maintenance person frequently performs updating in late night hours when each user doesn't use his or her terminal or uses the terminal less often.

In addition, IP terminals registered in a server are often installed in various places, such as countries or regions. Depending on the installation place, there may be a large time difference between the installation place of a server in which an IP terminal has been registered and the installation place of a terminal. In that case, the maintenance person often locates the installation place of each terminal and does the work of updating a plurality of times.

In the IP telephone system, as the number of registered IP terminals increases, the maintenance person has to perform updating an increasing number of times, taking into account the installation locations of IP terminals registered in the server. It is practically difficult to grasp the installation locations of all the IP terminals. Therefore, an update method which can prevent the user from using his or her terminal as little as possible and alleviate a load on the maintenance person has been desired strongly.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows a schematic configuration of a VOIP system according to a first embodiment;

FIG. 2 is a functional block diagram of an example of a exchange server shown in FIG. 1;

FIG. 3 shows an example of the stored contents of a management table shown in FIG. 2;

FIG. 4 shows an example of the stored contents of a firmware storage module shown in FIG. 2;

FIG. 5 is a flowchart to explain the procedure for controlling the exchange server when an IP terminal logins in the first embodiment;

FIG. 6 shows a sequence to explain the operation of transmitting and receiving information between a maintenance terminal, an IP terminal during login, and a exchange server in updating firmware in the first embodiment;

FIG. 7 shows a sequence to explain the operation of transmitting and receiving information between the maintenance terminal, the IP terminal during login, and the exchange server in updating firmware in the first embodiment;

FIG. 8A shows an example of a transmission format of firmware;

FIG. 8B shows an example of a transmission format of firmware;

FIG. 9 is a functional block diagram of a exchange server according to a second embodiment;

FIG. 10 shows an example of the stored contents of a management table shown in FIG. 9;

FIG. 11 shows a sequence to explain the operation of transmitting and receiving information between a maintenance terminal, an IP terminal during login, and a exchange server in updating firmware in the second embodiment; and

FIG. 12 shows a sequence to explain the operation of transmitting and receiving information between the maintenance terminal, the IP terminal during login, and the exchange server in updating firmware in the second embodiment.

### DETAILED DESCRIPTION

Various embodiments will be described hereinafter with reference to the accompanying drawings. In general, according to one embodiment, a server apparatus includes a timer, an acquisition module, a memory, and a controller. The timer measures a current time. The acquisition module acquires pieces of local time information set in each of the terminals. The memory stores in a management table terminal IDs in association with pieces of local time information acquired by the acquisition module, and time differences between the pieces of local time information and the current time measured by the timer. The controller refers to the management table when an update start time of the firmware is specified, and updates the firmware of each of the terminals sequentially, starting with a terminal with the sum of the time on the timer and the time difference is reached the update start time, based on a reference result of the management table.

### First Embodiment

A first embodiment is such that a maintenance person can determine an update start time of firmware arbitrarily and that firmware can be updated in a time zone when each IP terminal is not in use, taking into account the local time in each country or region where an IP terminal is installed.

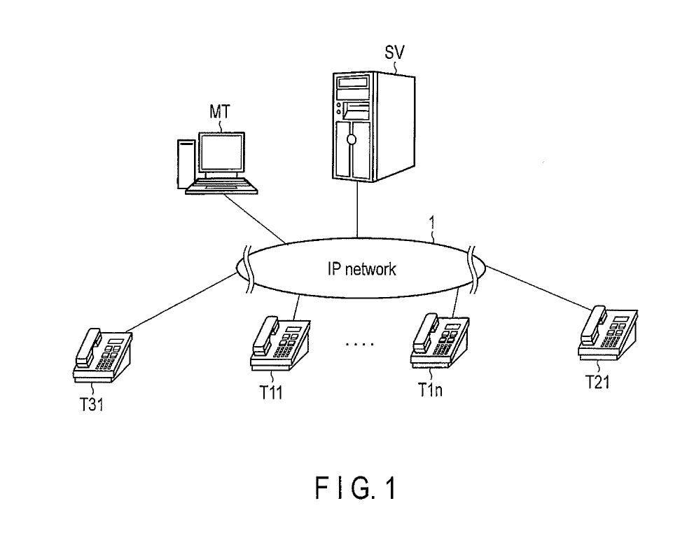

FIG. 1 shows a schematic configuration of a VOIP system according to a first embodiment.

In the VOIP system, suppose IP terminals T11 to T1n and maintenance terminal MT have been installed in country A, IP terminal T21 in country B, and IP terminal T31 in country C. In addition, a exchange server SV has been installed in country A. IP terminals T11 to T1n, T21, T31, and maintenance terminal MT have been registered in the exchange server SV via an IP network 1.

Each of IP terminals T11 to T1n, T21, T31 is a terminal that has a call processing function and a media information processing function. The exchange server SV has a switching control function of establishing a session between IP terminals T11 to T1n, T21, and T31 according to, for example, SIP. After the establishment of the session, IP packets are transmitted and received between a telephone terminal on the outgoing side and that on the incoming side by peer-to-peer connection, performing audio communication.

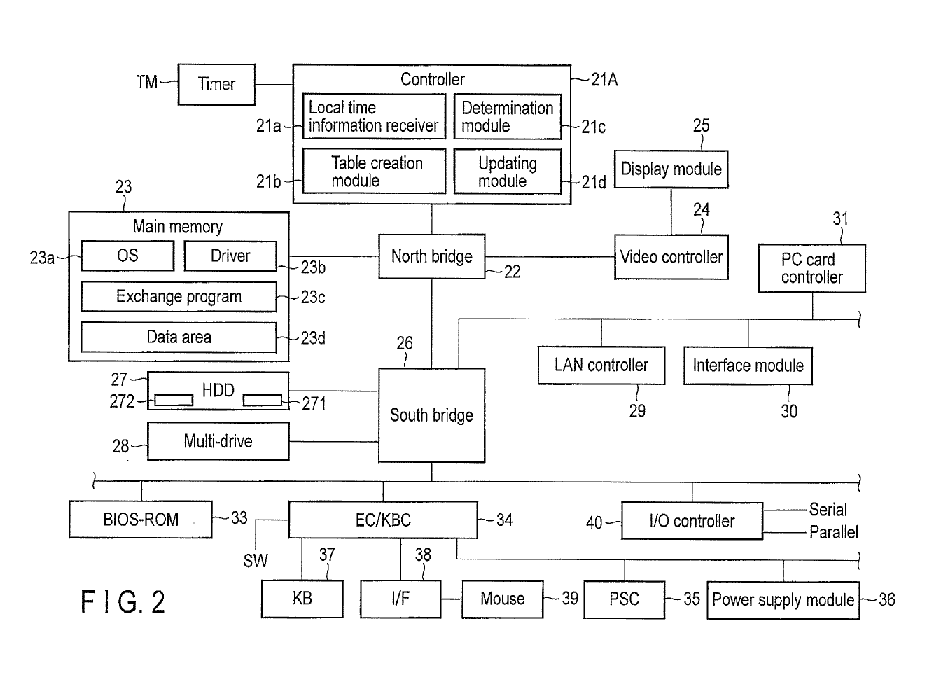

FIG. 2 is a functional block diagram of an example of the exchange server SV shown in FIG. 1.

The exchange server SV comprises a controller 21A, a north bridge 22, a main memory 23, a video controller 24, a display module 25, a south bridge 26, a hard disk drive (HDD) 27, a multi-drive 28, a LAN controller 29, an interface module 30, a PC card controller 31, a BIOS-ROM (Basic Input/Output System ROM) 33, EC/KBC (Embedded Controller/Keyboard Controller) 34, a power controller (PSC) 35, a power supply module 36, a keyboard (KB) 37, a mouse interface (I/F) 38, a mouse 39, and an I/O controller 40.

The controller 21A, which is chiefly composed of a CPU (Central Processing Unit), supervises overall control of the exchange server SV. Using the main memory 23 as a work area, the controller 21 executes an operating system (OS) 23a, a driver 23b, a exchange program 23c, and others loaded from the HDD 27 into the main memory 23.

The north bridge 22 includes various controllers that perform a bridging process between the controller 21 and south bridge 26, control of the main memory 23, control of the video controller 24, and others.

The video controller 24, which is connected to the north bridge 22 via an accelerated graphics port (AGP), performs control of data to be displayed on the display module 25. The display module 25, which includes a liquid-crystal display (LCD), displays data sent from the video controller 24 on the screen.

The south bridge 26, which is connected to the north bridge 22 via a hub link, includes various controllers that perform control of various devices (including the EC/KBC 34 and I/O controller) on an LPC (Low Pin Count) bus, various PCI devices (including the LAN controller 29, interface module 30, and PC card controller 31) on a PCI (Peripheral Component Internet) bus, a disk drive compatible with IDE (Integrated Drive Electronics), a USB device, and others.

The HDD 27, which is connected as a device compatible with primary IDE to the south bridge 26, is a built-in hard disk that stores various programs, including an OS and a exchange program, and various data items 23d. The multi-drive 28, which is connected as a device compatible with a secondary IDE to the south bridge 26, drives a CD-ROM, a DVD-ROM, and a CD-R/RW which are removable recording medium.

The LAN controller 29, which is connected as a PCI device to the south bridge 26, has a communication function conforming to the specification of wired LAN and communicates with a communication apparatus that has the same communication function.

The interface module 30, which is connected as a PCI device to the south bridge 26, has a communication function conforming to the specification of IP network 1 and performs processing in connection with the transmission and reception of IP packets.

The PC card controller 31, which is connected as a PCI device to the south bridge 26, conforms to the PCMCIA (Personal Computer Memory Card International Association) specification and controls various PC cards. The BIOS-ROM 33, which is connected to an LPC bus, stores a BIOS (Basic Input/Output System) that performs mainly the setting of the hardware of the exchange server SV when the power supply is turned on. The EC/KBC 34, which is connected to the LPC bus, controls the power controller 35 and an input device, such as the keyboard 37. The EC/KBC 34 is such that an embedded controller (EC) and a keyboard controller are integrally formed.

The power controller 35, which is connected to the EC/KBC 34 via an I2C bus, controls a voltage supplied to various parts of the exchange server SV. The power supply module 36 generates driving power and supplies the power to various parts of the exchange server SV. The keyboard 37, which is connected to the EC/KBC 34, informs the KBC of an input signal corresponding to the depression of each of the various keys. The mouse interface 38 interfaces a signal between the mouse 39 and the EC/KBC 34. The mouse 39, which is connected to the mouse interface 38, inputs signal by clicking. The I/O controller 40, which is connected to the LPC bus, performs input/output control of a serial signal or a parallel signal from/to the outside and further input/output control from/to the mouse 39.

In the exchange server SV, the exchange program 23c expanded over the main memory 23 cooperates with the LAN controller 29 and the like under the control of the controller 21A, thereby realizing a specific switching function. The exchange server SV loads the exchange program 23c into a general-purpose computer server and causes this server to execute the program, thereby realizing the function of switching between telephone terminals. Like a general-purpose computer, the exchange server SV uses a virtual memory system that makes a memory region in which data has been stored seem continuous from the viewpoint of software (such as processing) even if the region is physically discontinuous.

The controller 21A comprises a system timer TM, a local time information receiver 21a (hereinafter, referred to as the receiver 21a), a table creation module 21b, a determination module 21c, and an updating module 21d.

The system timer TM measures the local time of the exchange server SV. The receiver 21a receives local time information notified by each of IP terminals T11 to T1n, T21, and T31 when each of IP terminals T11 to T1n, T21, and T31 logins or when the local time is updated from each of IP terminals T11 to T1n, T21, and T31.

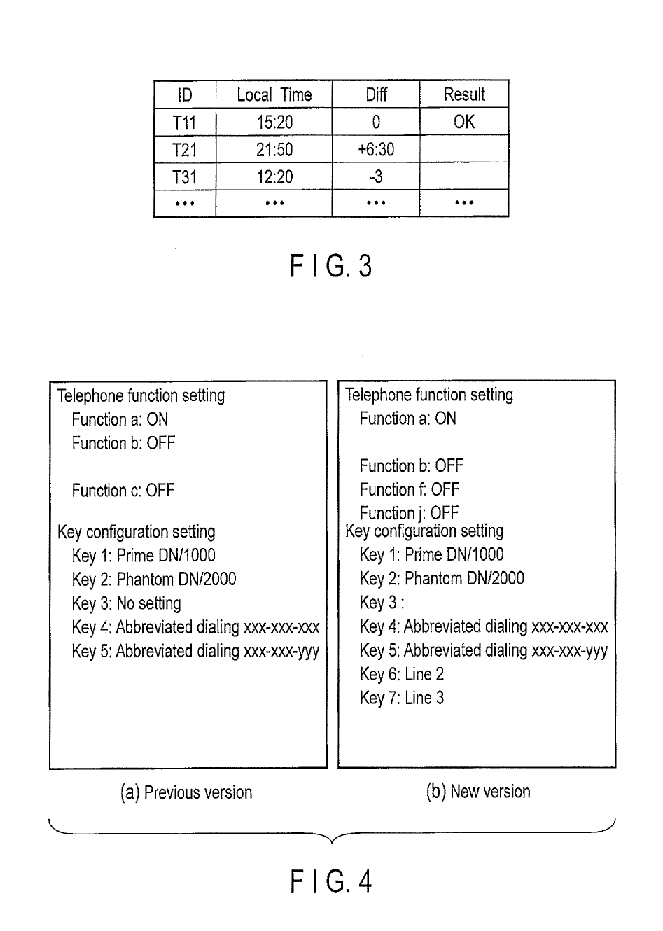

The table creation module 21b creates a management table 271 that causes terminal IDs identifying the corresponding IP terminals T11 to T1n, T21, and T31 to correspond to the pieces of local time information obtained by the receiver 21a and stores the table in the HDD 27. As shown in FIG. 3, the management table 271 is a table that causes terminal IDs of IP terminals T11 to T1n, T21, and T31 during login, the local times of countries or regions in which each IP terminal is installed, time differences, and firmware update results to correspond to one another. Here, suppose IP terminals T11 to T1n, T21, and T31 are currently logging in. The local times are times each of IP terminals T11 to T1n, T21, and T31 notifies at regular intervals. A time difference is calculated by comparing the notified local time with the current time measured by the system timer TM.

When the update start time of firmware has been specified, the determination module 21c refers to the management table 271 and determines whether the update start time coincides with the local time in the management table 271.

Based on the result of the determination by the determination module 21c, the updating module 21d updates the firmware of each of the terminals sequentially, starting with a terminal that has reached the update start time. In this case, the updating module 21d reads a new version of firmware stored in a firmware storage module 272 of the HDD 27 and transmits it to, for example, IP terminal T11 that has reached the update start time. Firmware includes, for example, telephone function setting and key configuration setting as shown in FIG. 4. In the telephone function setting, on/off is set for each function. In the key configuration setting, use is set for each key. That is, a new version of firmware of FIG. 4(b) is downloaded from the exchange server SV into IP terminal T11 in which a previous version of firmware of FIG. 4(a) has been set, thereby updating the firmware of IP terminal T11. Then, in IP terminal T11, “Function f” (e.g., a voice mail function) and “Function j” (e.g., an auto attendant function) can be newly used in place of “Function c.” In addition, “Capture of line 2” is newly allocated to “Key 6” and “Capture of line 3” is newly allocated to “Key 7.”

Furthermore, the updating module 21d updates the firmware of an IP terminal whose firmware has not been updated (that is, “Result” is not “OK”) in the management table 271.

Next, the operation of the VOIP system configured as described above will be explained.

(Login Operation)

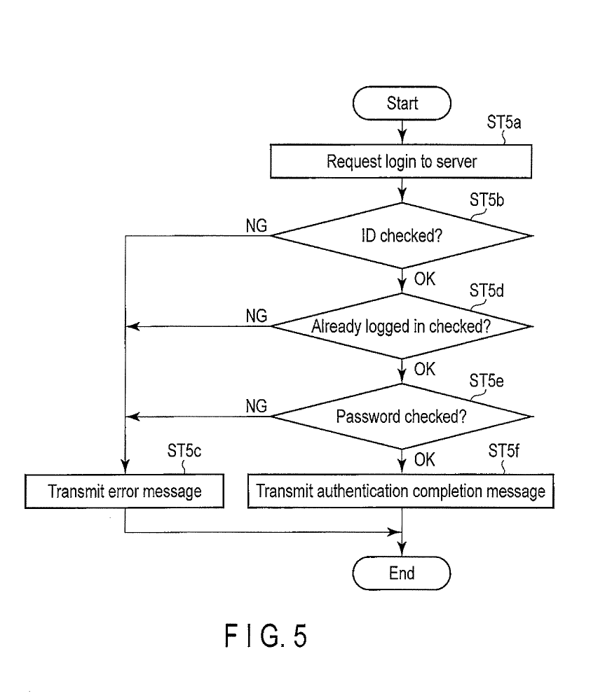

FIG. 5 is a flowchart to explain the procedure for controlling the exchange server SV when, for example, IP terminal T11 logins.

When IP terminal T11 is used, for example, the user of IP terminal T11 accesses the exchange server SV.

Then, the user of IP terminal T11 inputs a terminal ID and a password on a login screen to try to login to the exchange server SV. After the input has been completed, the terminal ID, password, and telephone number are transmitted to the exchange server SV.

Having received a login request from IP terminal T11, the exchange server SV moves from block ST5a to block ST5b. In block ST5b, the exchange server SV checks whether the terminal ID coincides with an ID group previously registered in the management table 271. If the terminal ID does not coincide with the ID group, the exchange server SV does not permit IP terminal T11 to login and moves from block ST5b to block ST5c. In block ST5c, the exchange server SV sends back to terminal PC1 an error message to the effect that the corresponding user name was not found.

To prevent double login with the same ID, the exchange server SV does not permit a new login even when the ID coincides with the registered ID if the terminal has already logged in with the ID. Then, the exchange server SV moves from block ST5d to block ST5c. In block ST5c, the exchange server SV sends back to IP terminal T11 an error message to the effect that IP terminal T11 has already logged in.

If the ID has no problem, the exchange server SV moves from block ST5d to block ST5e. In block ST5e, the exchange server SV authenticates the password. If the password is not correct, the exchange server SV moves from block ST5e to block ST5c. In block ST5c, the exchange server SV sends back to IP terminal Tll an error message to the effect that the password is not correct.

If all the checks have shown OK, the exchange server SV moves from block ST5e to block ST5f. In block ST5f, the exchange server SV sends back to IP terminal T11 a message of completion of authentication and registers IP terminal T11 as a user logging in the management table 271.

(Firmware Update)

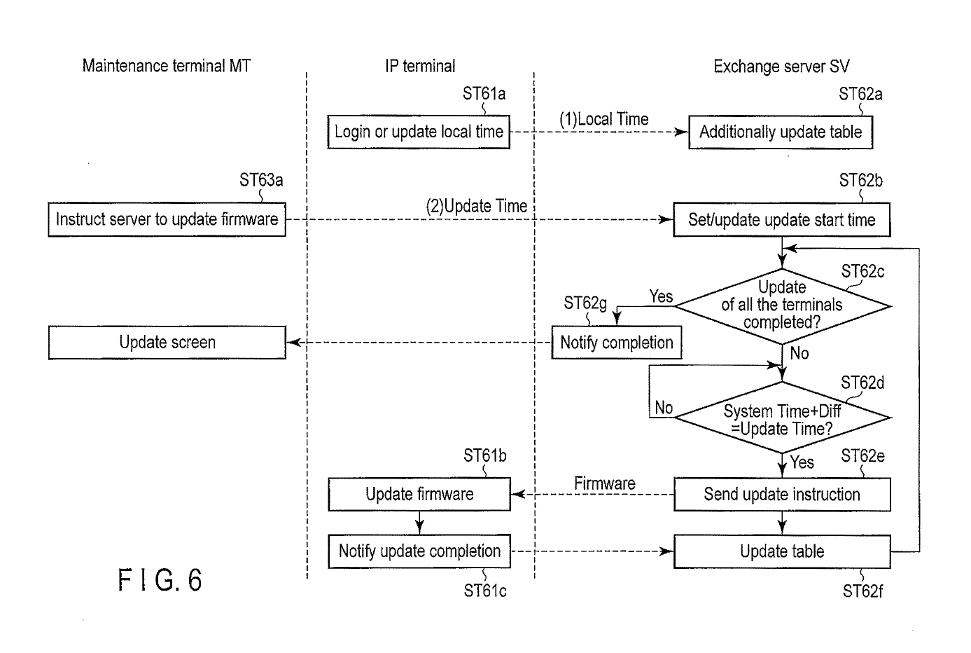

FIG. 6 shows a sequence to explain the operation of transmitting and receiving information between the maintenance terminal MT, IP terminals T11, T21, T31 during login, and the exchange server SV in updating firmware.

When each of IP terminals T11, T21, T31 logins to the exchange server SV, or when the local time is updated on each of IP terminals T11, T21, T31 (block ST61a), each of IP terminals T11, T21, T31 transmits local time information to the exchange server SV (FIG. 6 (1)).

The exchange server SV updates information on the time difference between the local time of an IP terminal that has received notice and the server time in the management table 271 (block ST62a).

Suppose the maintenance person instructs the exchange server SV to update firmware of IP terminals T11, T21, T31 via the maintenance terminal MT (block ST63a). Then, the maintenance terminal MT displays on an indicator (not shown) a message to prompt the user to input the version number and update start time of firmware. In this state, suppose the maintenance person operates the keyboard of the maintenance terminal MT to input the version number and update start time (e.g., 3:00) of the firmware. Then, the maintenance terminal MT informs the exchange server SV of the firmware update instruction and the update start time (FIG. 6(2)).

Having been informed of the update instruction and update start time, the exchange server SV refers to the management table 271, server time measured by the system timer TM, and the update start time and performs an update start determination process (block ST62b). Specifically, the exchange server SV performs a firmware update process on an IP terminal with the sum of the server time and time difference having reached the update start time.

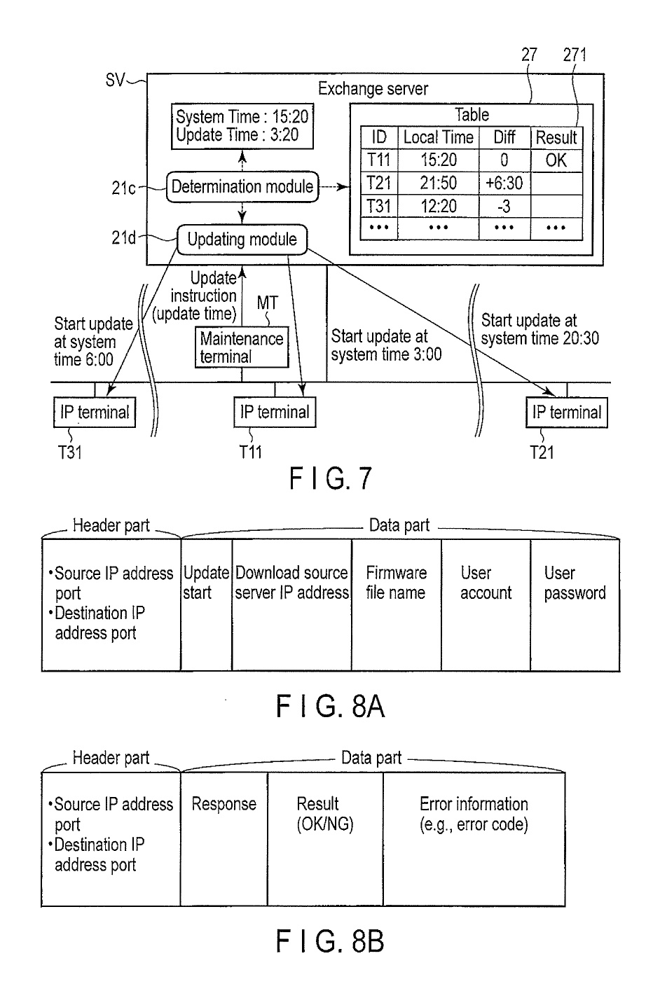

First, when having referred to the management table 271 and made sure that “Result” is not “OK,” the exchange server SV moves from block ST62c to block ST62d. In block ST62d, the exchange server SV determines whether the time obtained by adding the time difference corresponding to each of IP terminals T11, T21, T31 to the time measured by the system timer TM is equal to the update start time. As shown in FIG. 7, at the time when the system timer TM measures 3:00, the exchange server SV sends a firmware update instruction to IP terminal T11 where “time difference” is “0” (block ST62e). In this case, the firmware update instruction is composed of a header part and a data part as shown in FIG. 5A. The data part includes a message of “Update start,” the IP address of a server from which firmware is to be downloaded, a file name of firmware, a user account name in FTP access, and a password. The header part includes the IP address and port number of the transmitting exchange server SV and the IP address and port number of destination IP terminal T11.

IP terminal T11 that has received the firmware update instruction accesses the exchange server SV based on information included in the acquisition instruction according to a user operation or automatically and downloads a new version of firmware stored in the firmware storage module 272 of the HDD 27 of the exchange server SV, thereby updating the already set firmware to the new version of firmware (block ST61b).

Then, after the update of firmware has been completed, IP terminal T11 informs the exchange server SV of an update completion message (block ST61c). In this case, the update completion message is composed of a header part and a data part as shown in FIG. 8B. The data part includes a message of response, an update result (normal/abnormal), and error information (error code). The header part includes the IP address and port number of IP terminal T11 on the transmitting party and the IP address and port number of the exchange server SV on the destination party.

When having received an update completion message, the exchange server SV updates the “Result” corresponding to IP terminal T11 in the management table 271 to “OK” (block ST62f).

In addition, as shown in FIG. 7, at the time when the system timer TM measures 6:00 as shown in FIG. 7, the exchange server SV sends a firmware update instruction to IP terminal T31 whose “time difference” is “−3.” IP terminal T31 that has received a firmware update instruction accesses the exchange server SV based on a user operation or the storage location of firmware included automatically in the acquisition instruction. Then, the exchange server SV downloads a new version of firmware stored in the firmware storage module 272 of the HDD 27 of the exchange server SV and updates the already set firmware to the new version of firmware.

Then, having completed the update of firmware, IP terminal T31 informs the exchange server SV of an update completion message.

When having received the update completion message, the exchange server SV updates the “Result” corresponding to IP terminal T31 in the management table 271 to “OK”.

In addition, at the time when the system timer TM measures 20:30 as shown in FIG. 7, the exchange server SV sends a firmware update instruction to IP terminal T21 whose “time difference” is “+6:30.”

IP terminal T21 that has received a firmware update instruction accesses the exchange server SV based on a user operation or the storage location of the firmware included automatically in the acquisition instruction and downloads a new version of firmware stored in the firmware storage module 272 of the HDD 27 of the exchange server SV, thereby updating the already set firmware to the new version of firmware.

Then, after the update of the firmware has been completed, IP terminal T21 informs the exchange server SV of an update completion message.

When having received the update completion message, the exchange server SV updates “Result” corresponding to IP terminal T21 in the management table 271 to “OK”.

When the update of the pieces of firmware of all the terminals in the management table 271 has been completed properly in block ST62c (Yes), the exchange server SV informs the maintenance terminal MT of the completion of the update (block ST62g).

The exchange server SV subjects an IP terminal that has failed in update to an updating process again 24 hours later.

As described above, with the first embodiment, the management table 271 which causes terminal IDs identifying IP terminals T11, T21, T31 during login to correspond to pieces of local time information (local times and time differences) acquired from IP terminals T11, T21, T31 is stored and managed in the HDD 27 in the exchange server SV. When an update start time of firmware is specified at the maintenance terminal MT, the controller 21A determines whether the update start time coincides with the local time information, referring to the management table 271. The controller 21A updates sequentially the firmware of each of the IP terminals whose update start time coincides with the local time information.

Therefore, the probability that a situation where the user cannot use his or her terminal will take place can be reduced remarkably. In addition, the user has only to give an update instruction with arbitrary timing once, which decreases the burden substantially.

In addition, with the first embodiment, when the maintenance person inputs a firmware update instruction at the maintenance terminal MT, an input massage of update start time is displayed on the indicator. In this state, when the maintenance person inputs an arbitrary update start time, the exchange server SV is informed of the firmware update instruction and the update start time. Therefore, the maintenance person can determine the update start time of firmware by himself or herself, increasing the user's flexibility.

Furthermore, with the first embodiment, the management table 271 which causes terminal IDs, pieces of local time information, and firmware update completion results to correspond to one another is stored and managed in the HDD 27. When the maintenance terminal MT has given a firmware update instruction, the firmware of an IP terminal whose firmware has not been updated in the management table 271 is updated, which improves the reliability of firmware update.

### Second Embodiment

A second embodiment is configured to enable the update start time of firmware to be set finely on an IP terminal basis according to how each IP terminal is used.

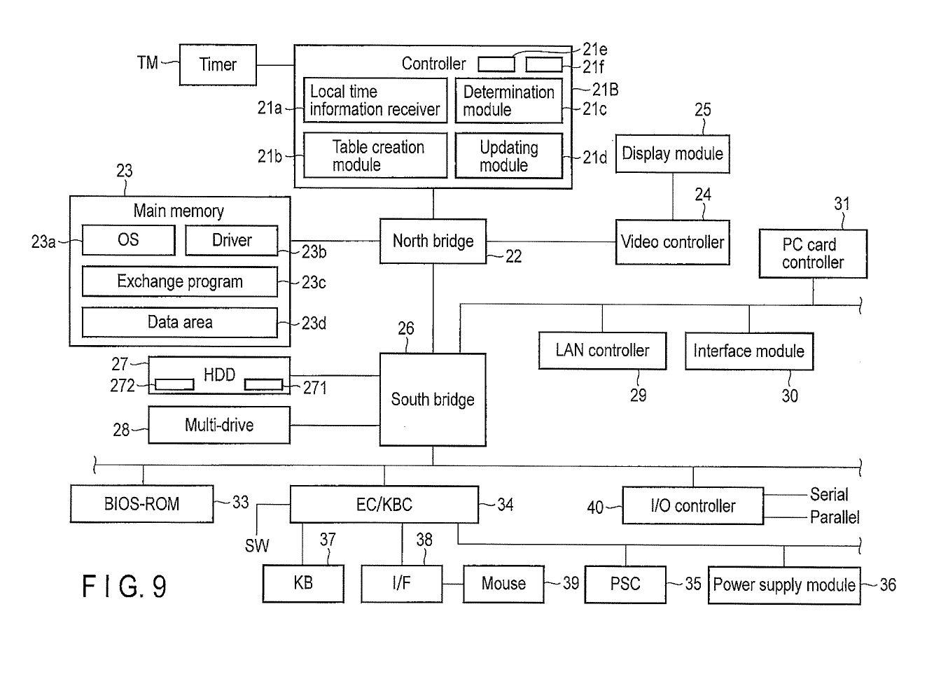

FIG. 9 is a functional block diagram of a exchange server SV according to the second embodiment. In FIG. 9, the same parts as those in FIG. 2 are indicated by the same reference numerals and a detailed explanation will be omitted.

A controller 21B comprises a terminal information receiver 21e (hereinafter, referred to as the receiver 21e) and an update start time determination module 21f (hereinafter, referred to as the determination module 21f). The receiver 21e receives pieces of information indicating the number of outgoing and incoming calls per hour and the number of key operations per hour reported by IP terminals T11, T21, T31 during login.

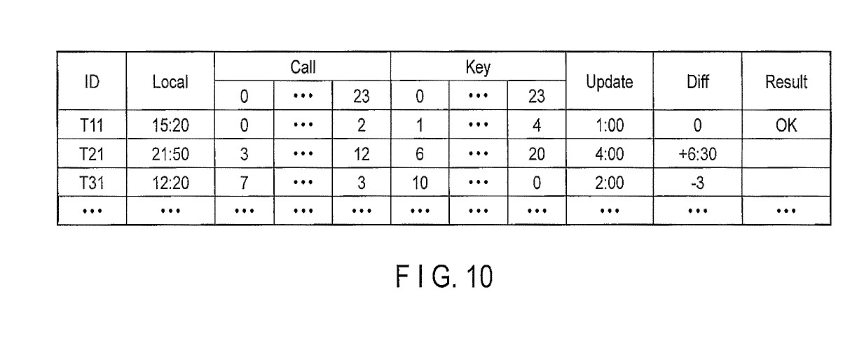

A table creation module 21b creates a management table 273 which causes terminal IDs identifying IP terminals T11 to Tin, T21, T31, local time information acquired by the receiver 21e, the number of outgoing and incoming calls per hour, and the number of key operations per hour to correspond to one another and stores the table 273 in an HDD 27. The management table 273 is a table which causes the terminal IDs of IP terminals T11 to Tin, T21, T31 currently logging in, the local time in a country or a region in which each IP terminal is installed, the number of outgoing and incoming calls per hour, the number of key operations per hour, time differences, and firmware update results to correspond to one another as shown in FIG. 10. In this case, suppose IP terminals T11, T21, T31 are currently logging in. The local times are times reported periodically by IP terminals T11 to T1n, T21, T31. The time differences are calculated by comparing the reported local time with the current time measured by a system timer M. The number of outgoing and incoming calls is a value indicating how many times an outgoing call was made every hour and an incoming call was made every hour from 00:00 to 24:00. The number of key operations is a value indicating how many times keys, including dial keys, transfer keys, function keys, were pressed every hour from 00:00 to 24:00.

The determination module 21f determines a time that minimizes the sum of the number of outgoing and incoming calls and the number of key operations in the management table 273 to be an update start time of the corresponding one of terminals T11, T21, T31 using a firmware update instruction from the maintenance terminal MT as a trigger. As for IP terminal T11, for example, since the number of outgoing and incoming calls is “0” and the number of key operations is “0” at “1:00,” the update start time in local time is determined to be “1:00.” As for IP terminal T21, for example, since the number of outgoing and incoming calls is “1” and the number of key operations is “1” at “4:00,” the update start time in local time is determined to be “4:00.” As for IP terminal T31, for example, since the number of outgoing and incoming calls is “2” and the number of key operations is “0” at “2:00,” the update start time in local time is determined to be “2:00.”

Next, the operation of a VOIP system with the above configuration will be explained.

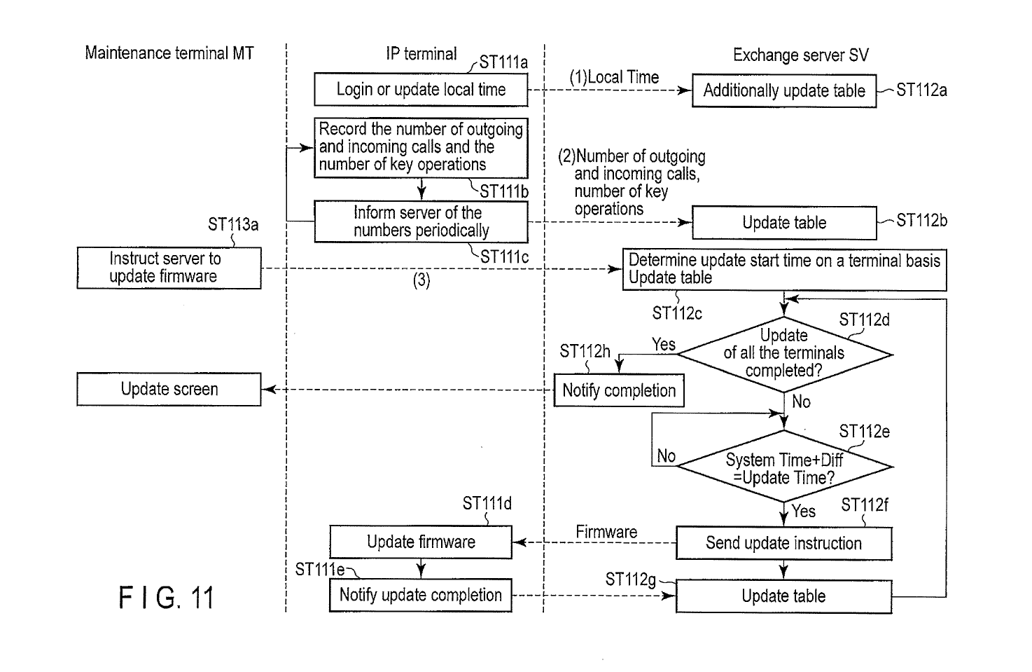

FIG. 11 shows a sequence to explain the operation of transmitting and receiving information between the maintenance terminal MT, IP terminals T11, T21, T31 during login, and the exchange server SV in updating firmware.

When each of IP terminals T11, T21, T31 logins to the exchange server SV, or when the local time is updated on each of IP terminals T11, T21, T31 (block ST111a), each of IP terminals T11, T21, T31 transmits local time information to the exchange server SV (FIG. 11(1)).

The exchange server SV updates information on the time difference between the local time of an IP terminal that has reported the local time information and the server time in the management table 273 (block ST112a).

After having logged in, each of IP terminals T11, T21, T31 totals the number of outgoing and incoming calls made in itself and the number of user's key operations and records the results in itself (block ST111b) and informs the exchange server SV of the hourly totaled numbers periodically (block ST111c, FIG. 11 (2)). The exchange server SV informed of the hourly totaled numbers adds/updates these pieces of information about the corresponding terminal in the table 273 (block ST112b).

Suppose the maintenance person instructs the exchange server SV to update firmware of IP terminals T11, T21, T31 via the maintenance terminal MT (block ST113a). Then, the maintenance terminal MT informs the exchange server SV of a firmware update instruction (FIG. 11 (3)).

Having been informed of the update instruction, the exchange server SV refers to a server time measured by the system timer TM and the number of outgoing and incoming calls per hour and the number of key operations per hour and performs an update start determination process (block ST112c). Specifically, the exchange server SV determines a time that minimizes the sum of the number of outgoing and incoming calls and the number of key operations to be an update start time. Then, the exchange server SV subjects an IP terminal that has reached the update start time to a firmware update process.

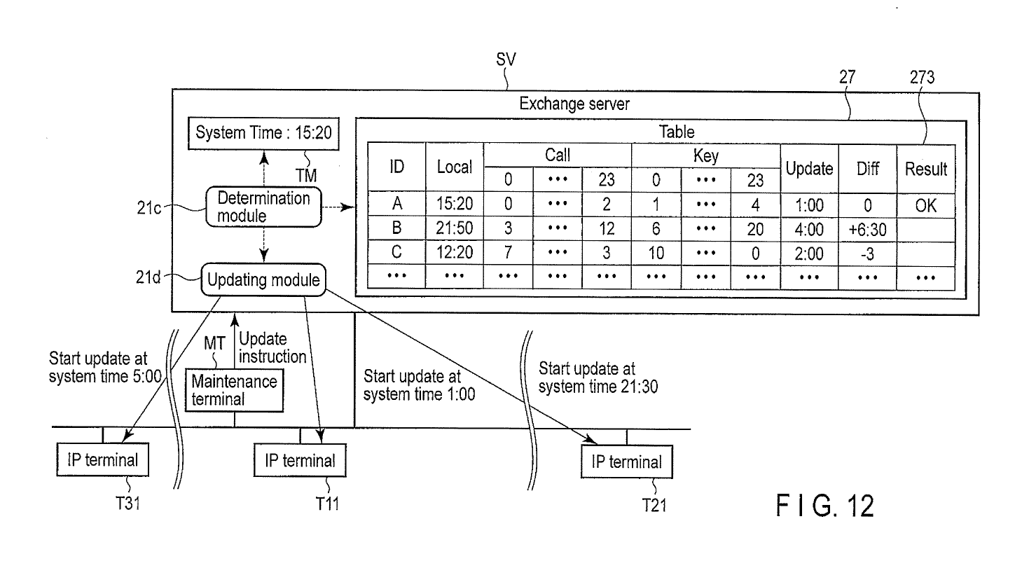

First, when having referred to the management table 273 and made sure that “Result” is not “OK”, the exchange server SV moves from block ST112d to block ST112e. In block ST112e, the exchange server SV determines whether the time obtained by adding the time difference corresponding to each of IP terminals T11, T21, T32 to the time measured by the system timer TM is equal to the update start time. As shown in FIG. 12, at the time when the system timer TM measures 1:00, the exchange server SV sends a firmware update instruction to IP terminal T11 where “time difference” is “0” (block ST112f).

IP terminal T11 that has received a firmware update instruction accesses the exchange server SV based on a user operation or the storage location of firmware included in the acquisition instruction automatically and downloads a new version of firmware stored in the firmware storage module 272 of the HDD 27 of the exchange server SV, thereby updating the already set firmware to the new version of firmware (block ST111d).

Then, after the update of the firmware has been completed, IP terminal T11 informs the exchange server SV of an update completion message (block ST111e).

When having received the update completion message, the exchange server SV updates “Result” corresponding to IP terminal T11 in the management table 273 to “OK” (block ST112g).

In addition, at the time when the system timer TM measures 5:00 as shown in FIG. 12, the exchange server SV sends a firmware update instruction to IP terminal T31 whose “time difference” is “−3.” IP terminal T31 that has received a firmware update instruction accesses the exchange server SV based on a user operation or the storage location of firmware included automatically in the acquisition instruction. Then, the IP terminal T31 downloads a new version of firmware stored in the firmware storage module 272 of the HDD 27 of the exchange server SV and updates the already set firmware to the new version of firmware.

Then, having completed the update of the firmware, IP terminal T31 informs the exchange server SV of an update completion message.

When having received the update completion message, the exchange server SV updates “Result” corresponding to IP terminal T31 in the management table 273 to “OK”.

In addition, at the time when the system timer TM measures 21:30 as shown in FIG. 12, the exchange server SV sends a firmware update instruction to IP terminal T21 whose “time difference” is “+6:30.”

IP terminal T21 that has received a firmware update instruction accesses the exchange server SV based on a user operation or the storage location of the firmware included automatically in the acquisition instruction and downloads a new version of firmware stored in the firmware storage module 272 of the HDD 27 of the exchange server SV, thereby updating the already set firmware to the new version of firmware.

Then, after the update of the firmware has been completed, IP terminal T21 informs the exchange server SV of an update completion message.

When having received the update completion message, the exchange server SV updates “Result” corresponding to IP terminal T21 in the management table 273 to “OK”.

When the update of the pieces of firmware of all the terminals in the management table 273 has been completed properly in block ST112d (Yes), the exchange server SV informs the maintenance terminal MT of the completion of the update (block ST112h).

The exchange server SV subjects an IP terminal that has failed in update to an updating process again 24 hours later.

As described above, with the second embodiment, the management table 273 which causes terminal IDs, pieces of local time information, the number of outgoing and incoming calls per hour, and the number of key operations per hour to correspond to one another is stored and managed in the HDD 27 in the exchange server SV. When the maintenance terminal MT gives a firmware update instruction, the controller 21B determines a time that minimizes the sum of the number of outgoing and incoming calls and the number of key operations to be an update start time of the corresponding IP terminal.

Therefore, the maintenance person can update firmware when each IP terminal is in an optimal time zone, taking no account of the start time of an updating process, which decreases the burden on the maintenance person more.

### Other Embodiments

The Other embodiments are not limited to the above embodiments. For example, while in the second embodiment, the number of outgoing and incoming calls per hour and the number of key operations per hours reported by each IP terminal have been recorded in the management table, the exchange server may acquire the number of outgoing and incoming calls per hour and the number of key operations per hours periodically from each IP terminal.

Furthermore, while in the first embodiment, the maintenance person has determined an update start time of firmware arbitrarily, an update start time held fixedly in the exchange server may be used.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server apparatus registering a plurality of terminals and executing communication connections between the terminals, wherein the terminals are set firmware, wherein the firmware is related to a exchange process between terminals, the server apparatus comprising:
a timer configured to measure a current time;
an acquisition module configured to acquire pieces of local time information set in each of the terminals;
a memory configured to store in a management table terminal IDs in association with pieces of local time information acquired by the acquisition module, and time differences between the pieces of local time information and the current time measured by the timer, wherein the terminal IDs corresponds with the terminals; and
a controller configured to refer to the management table when an update start time of the firmware is specified, and update the firmware of each of the terminals sequentially, starting with a terminal with the sum of the time on the timer and the time difference is reached the update start time, based on a reference result of the management table.

2. The server apparatus of claim 1, wherein the controller notifies a maintenance person of the start of update of the firmware and, when the maintenance person inputs an arbitrary update start time in response to the notice, refers to the management table and, updates the firmware of each of the terminals sequentially, starting with a terminal with the sum of the time on the timer and the time difference having reached the update start time, based on the reference result of the management table.

3. The server apparatus of claim 1, wherein the memory stores in a management table the terminal IDs in association with, the pieces of local time information, and the number of outgoing and incoming calls per hour and the number of key operations per hour notified by each of the terminals, and
the controller determines a time that minimizes the number of outgoing and incoming calls and the number of key operations in the management table to be an update start time of the corresponding terminal.

4. The server apparatus of claim 1, wherein the memory stores in the management table an update completion result of the firmware in association with the terminal ID, and
the controller refers to the management table and updates the firmware of a terminal whose firmware has not been updated, based on the reference result.

5. The server apparatus of claim 3, further comprising a terminal information acquisition module that acquires information indicating the number of outgoing and incoming calls per hour and the number of key operations per hour from the terminals.

6. A telephone system comprising:
a plurality of terminals are set firmware, wherein the firmware is related to a exchange process between terminals; and
a server apparatus configured to register a plurality of terminals and execute communication connections between the terminals,
the terminal comprises;
a transmitter configured to transmit local time information to the server apparatus at the time of registration or local time update, and
the server apparatus comprises;
a timer configured to measure a current time;
a receiver configured to receive pieces of local time information transmitted from the terminals,
a memory configured to store in a management table terminal IDs in association with pieces of local time information acquired by the acquisition module, and time differences between the pieces of local time information and the current time measured by the timer, wherein the terminal IDs corresponds with the terminals; and
a controller configured to refer to the management table when an update start time of the firmware is specified, and update the firmware of each of the terminals sequentially, starting with a terminal with the sum of the time on the timer and the time difference is reached the update start time, based on a reference result of the management table.

7. The telephone system of claim 6, wherein the controller notifies a maintenance person of the start of update of the firmware and, when the maintenance person inputs an arbitrary update start time in response to the notice, refers to the management table and updates the firmware of each of the terminals sequentially, starting with a terminal with the sum of the time on the timer and the time difference having reached the update start time, based on a reference result of the management table.

8. The telephone system of claim 6, wherein the terminal further comprises a notify module configured to notify the number of outgoing and incoming calls per hour and the number of key operations per hour periodically,
the memory stores in a management table the terminal IDs in association with, the pieces of local time information, and the number of outgoing and incoming calls per hour and the number of key operations per hour notified by each of the terminals, and
the controller determines a time that minimizes the number of outgoing and incoming calls and the number of key operations in the management table to be an update start time of the corresponding terminal.

9. The telephone system of claim 6, wherein the memory stores in the management table an update completion result of the firmware in association with the terminal ID, and
the controller refers to the management table and updates the firmware of a terminal whose firmware has not been updated, based on the reference result of the management table.

10. The telephone system of claim 6, wherein the server apparatus comprises a terminal information acquisition module configured to acquire information indicating the number of outgoing and incoming calls per hour and the number of key operations per hour from the terminals.

11. A firmware update control method used in a server apparatus registering a plurality of terminals and executing communication connections between the terminals, wherein the terminals are set firmware, wherein the firmware is related to a exchange process between terminals, the firmware update control method comprising:
measuring a current time with a timer;
acquiring pieces of local time information set in each of the terminals;
storing in a management table terminal IDs in association with pieces of local time information acquired by the acquisition module, and time differences between the pieces of local time information and the current time measured by the timer, wherein the terminal IDs corresponds with the terminals; and
referring to the management table when an update start time of the firmware is specified and updating the firmware of each of the terminals sequentially, starting with a terminal with the sum of the time on the timer and the time difference having reached the update start time, based on a reference result of the management table.

12. The firmware update control method of claim 11, wherein the updating comprises notifying a maintenance person of the start of update of the firmware and, when the maintenance person inputs an arbitrary update start time in response to the notice, referring to the management table and updating the firmware of each of the terminals sequentially, starting with a terminal with the sum of the time on the timer and the time difference having reached the update start time, based on the reference result of the management table.

13. The firmware update control method of claim 11, wherein the storing comprises storing in a management table the terminal IDs in association with, the pieces of local time information, and the number of outgoing and incoming calls per hour and the number of key operations per hour notified by each of the terminals, and
the updating comprises determining a time that minimizes the number of outgoing and incoming calls and the number of key operations in the management table to be an update start time of the corresponding terminal.

14. The firmware update control method of claim 11, wherein the storing comprises storing in the management table an update completion result of the firmware in association with the terminal ID, and
the updating comprises referring to the management table and updating the firmware of a terminal whose firmware has not been updated, based on the reference result of the management table.

15. The firmware update control method of claim 13, further comprising acquiring information indicating the number of outgoing and incoming calls per hour and the number of key operations per hour from the terminals.
